(19) United States
(12) Patent Application Publication
(10) Pub. No.: US 2016/0090795 A1
(43) Pub. Date: Mar. 31, 2016

(54) PIPE ELEVATOR HANDLE CLAMPS

(71) Applicants: Donald Haas, Burns Flat, OK (US); Justin Foust, Burns Flat, OK (US); Curtis Rogers, Burns Flat, OK (US); Kenneth Haas, Burns Flat, OK (US); Darryl Haas, Burns Flat, OK (US); Jason Rogers, Burns Flat, OK (US)

(72) Inventors: Donald Haas, Burns Flat, OK (US); Justin Foust, Burns Flat, OK (US); Curtis Rogers, Burns Flat, OK (US); Kenneth Haas, Burns Flat, OK (US); Darryl Haas, Burns Flat, OK (US); Jason Rogers, Burns Flat, OK (US)

(21) Appl. No.: 14/501,813

(22) Filed: Sep. 30, 2014

(51) Int. Cl. E21B 19/06; F16B 2/06; F16B 2/10

(52) U.S. Cl. CPC E21B 19/06; F16B 2/10; F16B 2/065

(57) ABSTRACT

A pipe elevator handle clamp for securing to pipe elevator handles to hold them in place comprises a top clamp section hingedly connected at one end to a bottom clamp section and releasably secured to each the bottom clamp section at the other end. The top clamp section and bottom clamp section define elongated structures that, when positioned together in the closed position, include two receiving holes for receiving and securing elevator handles. The hinge connection is defined by a hinge aperture that passes through both the top clamp section and bottom clamp section and has a hinge pin for providing the fixed axis of rotation therein. The device is secured around bull horns by hinging the top clamp section and bottom clamp section into the closed position and inserting a clamp fastener into a fastener channel that extends through the top clamp section into the bottom clamp section.

### BACKGROUND OF THE INVENTION

1. Field of the Invention

This invention relates generally to clamping devices and, more particularly, to locking clamps adapted to be fastened together to keep a pipe elevator closed.

2. Description of the Prior Art

The use and design of elevators in the drilling industry for wrapping the tool joint of a drill pipe, casing, or lift nipples to assist in the lifting or lowering of the same is well known. A problem which still exists, however, is that existing methods for securing elevator handles (or “bull horns”) together often rely on conventional ropes or clamps and do not always completely latch on to the elevator handles. Such circumstances may lead to an unacceptable risk of the securing apparatus coming off the elevator handles. Thus, there remains a need for a pipe elevator handle clamp which provides a hinging, lockable closure configured specifically for bull horns. It would be helpful if such a pipe elevator handle clamp eliminated the need for conventional ropes and clamps to secure bull horns in place. It would be additionally desirable for such a pipe elevator handle clamp to employ a hinged closure and removable fastening attachment to form the secure bond so as to remain durable and not require a plurality of additional components.

The Applicant's invention described herein provides for a pipe elevator handle clamp adapted to allow a user to secure pipe elevator handles in place when the pipe elevators are wrapped around are target component. The primary components in Applicant's pipe elevator handle clamp are two clamp sections hingedly attached and a fastening screw. When in operation, the pipe elevator handle clamp enables more effective and efficient attachment to pipe elevator handles, thereby improving the security of the hold on said handles. As a result, many of the limitations imposed by prior art structures are removed.

### SUMMARY OF THE INVENTION

A pipe elevator handle clamp for securing to pipe elevator handles to hold them in place. The pipe elevator handle clamp comprises a top clamp section hingedly connected at one end to a bottom clamp section and releasably secured to each the bottom clamp section at the other end. The top clamp section and bottom clamp section define essentially mirror image elongated structures that, when positioned together in the closed position, include two handle receiving holes for receiving and securing conventional elevator handles.

The hinge connection is defined by a hinge aperture that passes through both the top clamp section and bottom clamp section and has a hinge pin for providing the fixed axis of rotation therein. The pipe elevator handle clamp is fastened around bull horns by hinging the top clamp section and bottom clamp section into the closed position and inserting a clamp fastener into a fastener channel that extends through the top clamp section into the bottom clamp section, thereby providing a lock on the bull horns that will better resist coming off.

It is an object of this invention to provide a need for a pipe elevator handle clamp which provides a hinging, lockable closure configured specifically for bull horns.

It is another object of this invention to provide a pipe elevator handle clamp that eliminates the need for conventional ropes and clamps to secure bull horns in place.

It is yet another object of this invention to provide a pipe elevator handle clamp that employs a hinged closure and removable fastening attachment to form the secure bond so as to remain durable and not require a plurality of additional components.

These and other objects will be apparent to one of skill in the art.

### BRIEF DESCRIPTION OF THE DRAWINGS

FIG. 1A is a front side cross sectional view of a pipe elevator handle clamp built in accordance with the present invention in the closed position.

FIG. 1B is a hinge side elevational view of a pipe elevator handle clamp built in accordance with the present invention in the closed position.

FIG. 1C is a top plan view of a pipe elevator handle clamp built in accordance with the present invention in the closed position.

### DETAILED DESCRIPTION OF THE INVENTION

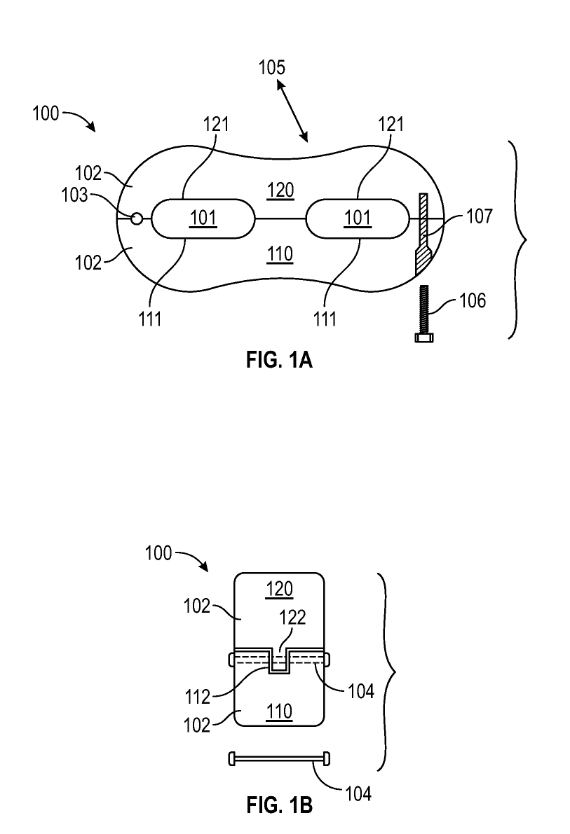

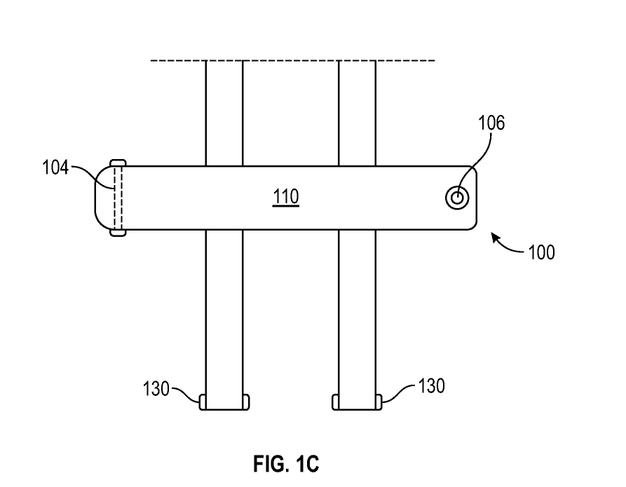

Referring now to the drawings and in particular FIGS. 1A, 1B, and 1C, a pipe elevator handle clamp 100 is shown having a top clamp section 110 hingedly connected at one end to a bottom clamp section 120 and releasably secured to each the bottom clamp section 120 at the other end. The top clamp section 110 and bottom clamp section 120 define essentially mirror image elongated structures having two arcuate valleys 111, 121 on their side that is to engage the opposing clamp section. In this regard, when the top clamp section 110 and bottom clamp section 120 are positioned together in the closed position illustrated by FIG. 1A, the first clamp section's 110 arcuate valleys 111 align with the second clamp section's 120 corresponding arcuate valleys 121 to form handle receiving holes 101. The handle receiving holes 101, which provide receiving and securing structures in which can be placed around conventional elevator handles 130 and secured them in place, have an elongated shaped that prevents pipe elevator handles 130 from slipping out as long as the pipe elevator handle clamp 100 is in the closed position.

The hinge connection between the top clamp section 110 and the bottom clamp section defines a recessed edge portion 112 of the top clamp section 110 and a lip edge portion 122 of the bottom clamp section 120, both disposed on the hinge side 102 of the pipe elevator handle clamp 100. A hinge aperture 103 that passes straight through the recessed edge portion 112 and the lip edge portion 122 when the top clamp section 110 and bottom clamp section are aligned in accordance with the present invention receives a hinge pin 104. The hinge pin 104 thereby provides the fixed axis of rotation upon which the top clamp section 110 and the bottom clamp section 120 can rotate relative to one another, solely in a clamping/opening direction 105.

When the top clamp section 110 and the bottom clamp section 120 are rotated to the closed position, they are secured together through a clamp fastener, defined as an allen head set screw 106 in the preferred embodiment, being inserted into a fastener channel 107 that extends from the exterior surface of the top clamp section 110 through the top clamp section 110 and into the bottom clamp section 120. When the top clamp section 110 and the bottom clamp section 120 are secured around the bull horns of a pipe elevator and hinged to the closed position, thereby aligning the fastener channel 107 in the top clamp section 110 and bottom clamp section 120, the set screw 106 is screwed into fastener channel 107 to secure the top clamp section 110 and bottom clamp section 120 together. When it is desired to remove or reposition a pipe elevator handle clamp 100 secured to bull horns, the set screw 106 is removed from the fastener channel and the top clamp section 110 and bottom clamp section 120 are hinged out of the closed position.

In the preferred embodiment, the top clamp section 110 and bottom clamp section 120 are constructed of aluminum and the pipe elevator handle clamp 100 measures 2 ⅞ by 3 ½ by 2 ⅜ inches.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A pipe elevator handle clamp for releasbly closing on conventional pipe elevator handles, comprising:
a top clamp section having an elongated body with a top clamp interior surface, wherein the top clamp interior surface includes a plurality top clamp valleys therein;
a bottom clamp section having an elongated body with a bottom clamp interior surface, wherein the bottom clamp interior surface includes a plurality bottom clamp valleys therein and the top clamp section and bottom clamp section are connectable and moveable in and out of a closed position; and
wherein in the closed position, the top clamp interior surface is positioned against the bottom clamp interior surface with the top clamp valleys aligned with the bottom clamp valleys, resulting in each top clamp valley joining with one corresponding bottom clamp valley to form a handle receiving hole in the combined top clamp section and bottom clamp section structure.

2. The pipe elevator handle clamp of claim 1, wherein the top clamp section is rotatably connected to said bottom clamp section.

3. The pipe elevator handle clamp of claim 2, wherein:
the top clamp section includes a top hinge side;
the bottom clamp section includes bottom hinge side; and
the top hinge side is hingedly connected to the bottom hinge side.

4. The pipe elevator handle clamp of claim 3, wherein the top hinge side includes a recessed edge portion and the bottom hinge side includes a lip edge portion, each aligned together with a hinge aperture that passes straight through, thereby enabling a single hinge pin to pass straight through both the recessed edge portion and lip edge portion.

5. The pipe elevator handle clamp of claim 1, wherein each of the top clamp valleys and bottom clamp valleys define arcuate valleys, thereby configuring in the handle receiving holes to have an elongated shaped that prevents conventional pipe elevator handles from slipping out when the pipe elevator handle clamp is closed thereon.

6. The pipe elevator handle clamp of claim 1, wherein the top clamp section and bottom clamp section each share a fastener channel configured to receive a clamp fastener on the side opposite the top hinge side.

7. The pipe elevator handle clamp of claim 6, wherein the clamp fastener is a screw.
